(19) United States
(12) Patent Application Publication
(10) Pub. No.: US 2022/0400705 A1
(43) Pub. Date: Dec. 22, 2022

(54) NEAT REACTION PRODUCT OF CALCIUM AND VOLATILE FATTY ACIDS AS NUTRITIONAL SUPPLEMENT FOR LIVESTOCK AND POULTRY

(71) Applicant: Zinpro Corporation, Eden Prairie, MN (US)

(72) Inventors: Peter A. Stark, Inver Grove Heights, MN (US); Jason Bernard Wibbels, Eden Prairie, MN (US)

(21) Appl. No.: 17/304,194

(22) Filed: Jun. 16, 2021

(51) Int. Cl. A23K 20/158; A23K 20/24; A23K 40/00; A23K 50/10; A23K 50/30; A23K 50/75

(52) U.S. Cl. CPC A23K 20/158; A23K 20/24; A23K 40/00; A23K 50/10; A23K 50/30; A23K 50/75

(57) ABSTRACT

A process and composition for animal feed supplements without substantial foul odor problems prepared by reacting neat, a calcium metal source selected from the group consisting of calcium oxide and calcium hydroxide with a low molecular weight volatile fatty acid selected from the group consisting of butyric acid, isobutyric acid, 2 methyl butyric acid, valeric acid and isovaleric acid. Under controlled reaction conditions (neat) and a controlled weight ratio of the two reactants a product that is substantially odor free and useful as an animal feed supplement results.

### FIELD OF THE INVENTION

Production and use of essentially odor free isoacid nutrients for livestock, swine, and poultry.

### BACKGROUND OF THE INVENTION

It is well-known in the animal nutrition field that volatile fatty acids such as butyric acid, isobutyric acid, and valeric acid improve milk production in dairy cows and are also useful nutritional supplements. However, one of the main drawbacks of using these volatile acids for these purposes is their strong odor. The odor has sometimes been described as smelling of extreme rancidity, vomit, and/or extreme body odor. Eastman Kodak originally produced these compounds for the animal industry, see U.S. Pat. No. 4,804,547, which discloses making calcium salts of the isoacids, but they never saw widespread use, due to their odor. The odor was less a problem to the animals eating these as fermentation enhancers than it was to the workers producing them. Oftentimes workers could not stand the smell, sickened and some even claimed adverse medical effects. There were some efforts to decrease odor, such as U.S. Pat. No. 4,376,790, which relates to decreasing odor by making ammonium salts of the isoacids. Another attempt at improving this type of product was to make the imines from urea and corresponding acid aldehydes (see Publication No. WO 84/006769). However, the aldehydes are significantly more expensive than the acids and this therefore never became a viable product. Finally, a more recent odor reduction technique involves linking isoacids to pendant polycarboxylic acids derived from materials such as pectin, see Stark U.S. Pat. No. 10,034,986.

Other ways of making salts of volatile organic acids less smelly include coating the low molecular weight volatile fatty acid with a carbohydrate or a protein. This technique is described in for example European Patent 2,727,472 published Oct. 4, 2017, in European Bulletin 2017/40. In this patent the matrix of the low molecular weight volatile fatty acid and another fatty substance are mixed, and then extruded to provide an encapsulated product as a stomach stable fat matrix. Problems can occur with such coatings, including only partial coating, increased cost, ineffective and incomplete covering of the putrid smell, and of course increased complexity of processing with the use of more ingredients.

“Isoacids” as used here is the collective term for the branched-chain fatty acids: isobutyric, 2-methylbutyric and isovaleric acid and the straight-chain valeric and butyric acids_{[A1]} all of which are naturally produced in ruminant's digestive tracts. They are mainly built up from the degradation products of the amino acids valine, isoleucine, leucine and proline. Besides their role as specific nutrients for the ruminal cellulolytic bacteria, isoacids seem to have a general positive influence on microbial fermentation. Only limited information is available on the influence of isoacids on the intermediary metabolism. Alteration of the growth hormone and indirect effects (via amino acids) on mammary gland and skeletal muscles are suggested. From a review of cattle experiments, a nutritional supplement of isoacids may also have a positive influence on milk production. For a scientific discussion of isoacids in the digestion and metabolism of the ruminant, see Animal Feed Science and Technology, 18 (1987) 169-180.

There is a continuing need for a convenient low-cost process to lower the odor so as to make volatile fatty acid derived fermentation enhancers a viable feed supplement product that can be used without adverse reaction by production works and/or the animals being supplemented.

The present Inventors have discovered surprisingly that certain reaction products resulting from neat reactions not only make a useful supplement but that they make a supplement with little or no foul smell that can be used without need for any smell masking agent such as encapsulating fatty acids coatings.

In short, the present invention at least with respect to reaction products between low molecular weight volatile fatty acids and calcium oxide and calcium hydroxide (particularly when conducted at preferred weight ratios expressed below) result in a useful product that needs no encapsulation to reduce putrid smell. In short it fulfills the continuing need as earlier expressed.

### SUMMARY OF THE INVENTION

This invention overcomes the putrid odor problems of low molecular weight volatile fatty acids as nutritional supplements for livestock and poultry by reacting a calcium ion source with low molecular weight volatile fatty acid in a solid phase neat reaction, and then using the reaction product as a nutritional supplement.

### DETAILED DESCRIPTION OF THE PREFERRED EMBODIMENTS

Importantly it has been found that the non-putrid smelling isoacid salts of calcium useful for this invention can be produced directly in a reaction mixture of the isoacid and either calcium hydroxide or calcium oxide in solid form with the reactions conducted neat directly in mixers at the normal exothermic reaction temperatures that result from the acid/base reaction which occurs in situ.

In fact, the reaction can be conducted in for example a Hobart mixer, a twin screw extruder, a vacuum paddle dryer, a ribbon blender, and even small hand batches can be made in ordinary beakers and the like.

Multiple experiments were conducted utilizing twin screw extruders. The ZSK 26 and ZSK 34 models from Coperion were used for initial development and scale-up modeling, respectively. Each extruder was set-up in a multi-barrel configuration with corresponding screw elements to enable raw material feed and injection as well as ensure adequate mixing, conveying, and discharge.

The solid calcium hydroxide was introduced through a side feeder. The respective isoacid was injected in one of the downstream ports. The mixture of the calcium hydroxide and isoacid was conveyed through mixing elements and discharged through an open discharge. Multiple variables were independently adjusted to optimize the process including the temperature of the mixture inside the extruder, the screw speed, the raw material feed ratio, and the overall feed rate. As the material reacted, it transitioned from a free-flowing slurry to a clay-like solid to a brittle solid. As such, residence time in the extruder was a key consideration during the experiments.

The Solidaire paddle dryer from BEPEX was also used for experimentation. The Solidaire paddle dryer consists of a horizontal agitating rotor inside a cylindrical vessel. The vessel is equipped with a heat transfer jacket utilizing steam as the heat source. The rotor is made up of adjustable-pitch and depth paddles, providing fine control over material residence time and material layer thickness.

Experiments were conducted at defined overall feed rates, adjusted raw material feed ratios, rotor speeds, and jacket temperatures. Residence time was again a consideration during the experiments. To allow for additional mixing/reaction time, a twin-rotor low-speed paddle mixer was used in conjunction with the paddle dryer.

Importantly the reaction must be conducted in controlled molar ratios, varying within the range of ratios herein expressed to achieve odor free products. For reasons not particularly known or understood and not wishing to be bound by theory, there appears to be something in the chemistry that when one doesn't have the complete reaction to 1:2 metal to acid the hold of the acid as attached is tighter. The 1:2 with both calcium oxide and calcium hydroxide smells more than the lower ratios.

The best results are obtained less than 1 to 2 ratios since the closer one gets to 1:2 ratio it will begin smelling more. These best results smell wise are obtained when the metal:acid ratio is within the range of about 1:1 to about 1:2 with the most preferred range being 1:1.5-1:1.9.

From time to time, it has been mentioned that this reaction is a neat reaction. Neat is used in the context of chemical reactions to refer to a reaction conducted without added solvents, carriers, or catalysts i.e., with just the reactants together. This is illustrated in the below examples, where the products are made and then headspace odor measured.

In the below examples the term “IBA” refers to isobutyric acid, “BA” to butyric acid, “2MBA” to 2 methyl butyric acid, “3MBA” to 3 methyl butyric acid, and “VA” to valeric acid. In the following examples the importance of using neat reactions and using the proper ratio of calcium oxide or calcium hydroxide to form the low molecular weight salts of volatile fatty acid are illustrated, both with respect to hand mixed samples and use of high shear mixing devices commonly available.

Smell is measured by using gas chromatograph headspace analysis. Measured headspace ppm less than 15,000 ppm constitutes tolerable odor.

### EXAMPLES

The procedure for the hand mixed samples of Examples 1-5 is as follows:

### Example 1

“X” gr of CaO or Ca(OH)2 as indicated is weighed in a 100 mL beaker. To this solid is added “y” gr of the acid and the mixture is stirred by hand. Heat is given off in the mixing.

The solid is allowed to cool and then sealed in a container until analyzed by GC/MS head space analysis, for odor or volatile component, measured in parts per million.

| | | Mole | IBA | total |
|---|---|---|---|---|
| CaO wt(gr) | Moles | Ratio | wt(gr) | wt(gr) |
| 5.12 | 0.09 | 1.20 | 9.65 | 14.77 |
| 5.83 | 0.10 | 1.50 | 13.74 | 19.57 |
| 5.44 | 0.10 | 1.75 | 14.96 | 20.40 |
| 5.27 | 0.09 | 2.00 | 16.56 | 21.83 |

### Example 1 Table (Headspace Analysis)

| Average PPM | Ratio (IBA/Ca) |
|---|---|
| 15.7 | 1 |
| 5792.5 | 1.5 |
| 8207.7 | 1.75 |
| 10714.6 | 2 |

### Example 2

| CaO | | Mole | IBA | total |
|---|---|---|---|---|
| wt(gr) | Moles | Ratio | wt(gr) | wt(gr) |
| 8.7 | 0.16 | 1 | 13.67 | 22.37 |
| 7.9 | 0.14 | 1.5 | 18.62 | 26.52 |
| 9.1 | 0.16 | 2 | 28.59 | 37.69 |
| 7.8 | 0.14 | 2.1 | 25.74 | 33.54 |
| 7.5 | 0.13 | 2.2 | 25.92 | 33.42 |
| 8.4 | 0.15 | 2.3 | 30.35 | 38.75 |
| 8.2 | 0.15 | 2.5 | 32.21 | 40.41 |
| 8.9 | 0.16 | 3 | 41.95 | 50.85 |

### Example 2 Table (Headspace Analysis)

| Ratio | Free IBA |
|---|---|
| (IA/Metal) | (average ppm) |
| 1.0 | 14.8 |
| 1.5 | 3724.4 |
| 2.0 | 8996.4 |
| 2.1 | 14960.8 |
| 2.2 | 23406.0 |
| 2.3 | 30578.0 |
| 2.5 | 70008.6 |
| 3.0 | 237036.0 |

The result in Example 2, as illustrated in Table 2 demonstrates the dramatic uptick in putrid smell, measured in ppm in headspace as the mole ratio exceeds 1:2.

### Example 3

| Ca(OH)2 wt | | Mole | nBA | Total |
|---|---|---|---|---|
| (gr) | Moles | Ratio | wt(gr) | Weight(gr) |
| 6.9 | 0.09313 | 1.5 | 12.31 | 19.21 |
| 7.3 | 0.098529 | 1.75 | 15.19 | 22.49 |
| 7.2 | 0.097179 | 2 | 17.12 | 24.32 |

### Example 3 Table (Headspace Analysis)

| Ratio | |
|---|---|
| (nBA/Ca) | Average PPM |
| 1.5 | 11.9 |
| 1.75 | 9.4 |
| 2 | 10.1 |

### Example 4

| Ca(OH) | | Mole | 2MBA | Total Weight |
|---|---|---|---|---|
| 2wt(gr) | Moles | Ratio | (gr) | (gr) |
| 12.1 | 0.163315 | 1 | 16.67935 | 28.78 |
| 12.3 | 0.166014 | 1.5 | 25.43256 | 37.73 |
| 11.9 | 0.160615 | 1.75 | 28.7064 | 40.61 |
| 12.6 | 0.170063 | 2 | 34.73716 | 47.34 |
| 12.4 | 0.167364 | 2.1 | 35.89506 | 48.30 |
| 12.7 | 0.171413 | 2.2 | 38.51413 | 51.21 |
| 12.5 | 0.168714 | 2.3 | 39.63069 | 52.13 |
| 12.6 | 0.170063 | 2.5 | 43.42145 | 56.02 |
| 12.9 | 0.174113 | 3 | 53.34635 | 66.25 |

### Example 4 Table

| Ratio | Free 2MB |
|---|---|
| (IA/Metal) | (average ppm) |
| 1.0 | 7106.8 |
| 1.5 | 35.7 |
| 2.0 | 6972.5 |
| 2.1 | 12597.4 |
| 2.2 | 17097.9 |
| 2.3 | 21316.5 |
| 2.5 | 27580.1 |
| 3.0 | 146751.3 |

As evidenced in Example 4 with use of Ca(OH)₂ and 2 MB, results similar to Example 2 were observed.

### Example 5

| Ca(OH)2 wt | Mole Ratio | Mole Ratio | 2MBA | Total Weight |
|---|---|---|---|---|
| 8.9 | 0.120124 | 1 | 12.26828 | 21.17 |
| 8.7 | 0.117425 | 1.5 | 17.98889 | 26.69 |
| 8.6 | 0.116075 | 1.75 | 20.7458 | 29.35 |
| 8.9 | 0.120124 | 2 | 24.53656 | 33.44 |

### Example 5 Table (Headspace Analysis)

| Ratio | Free 2MB |
|---|---|
| (IA/Metal) | (average ppm) |
| 1.9 | 20.7 |
| 2 | 5395.5 |
| 2.1 | 9671.8 |
| 2.4 | 17533.6 |

### Example 6

In Example 6 samples were made using calcium sources and isovaleric acid with the ratios shown in Table 6, the headspace measurements in ppm are shown for each.

### Example 6 (Ca:Isovaleric Acid Salts)

| | Ca:Acid | Headspace |
|---|---|---|
| Ca Source | Ratio | analysis ppm |
| CaO | 1:2 | 2354 |
| Ca(OH)2 | 1:1.9 | 2312 |

The importance of the respective mole ratios of reactants to effectively reduce or eliminate putrid odor is demonstrated by the produced data relating to headspace measurements in parts per million in the table form ppm data.

### Example 7

In this Example 7, the Ca(OH)2 was added to a Hobart mixer and the mixing motor was started. To this was added the liquid acid neat. The acid used was a mixture of IBA and 2MBA (70% IBA/30% 2MBA). The mixer continued mixing for 3 hours and the product was collected and tested for head space analysis. Table 7 reports the collected data.

TABLE 7
(headspace analysis)

| Ratio Ca:Acid | HS ppm |
|---|---|
| 1:1.8 | 3887 2MBA, 6460 IBA |

### Example 8

Another Hobart mixture was made using Ca(OH)2 and butyric acid as the reactants. Table 8 reports the collected data.

TABLE 8
(headspace analysis)

| Ratio Ca:butyric aicd | ppm |
|---|---|
| 1:1.9 | 737 |

### Example 9

Examples 9 and 10, and 11 are neat runs using a solidare paddle mixer/dryer as previously described and made by BEPEX. The mole ratio of IVA to calcium source, and the headspace ppm measurements are in Table 9. The calcium source was Ca(OH)2.

TABLE 9
Paddle Dryer

| Average | Ratio |
|---|---|
| PPM | (IBA/Ca) |
| 1054.4 | 1.57 |
| 2085.8 | 1.42 |
| 1133.3 | 1.18 |

### Example 10

TABLE 10
Paddle Dryer, (headspace analysis)

| Average | Ratio |
|---|---|
| PPM | (IBA/Ca) |
| 656.7 | 1.48 |
| 10595.8 | 1.74 |
| 1833.3 | 1.54 |

In the paddle dryer neat run is shown in Example 10 the calcium source Ca(OH)2.

### Example 11

Still another paddle dryer example using as the calcium source Ca(OH)2 is set forth in Table 11.

TABLE 11
(headspace analysis)

| Average | Ratio |
|---|---|
| PPM | (IBA/Ca) |
| 1660.9 | 1.25 |
| 1734.4 | 1.42 |
| 4616.4 | 1.49 |

### Example 12

Yet another paddle dryer experiment with Ca(OH)2 and 2MBA with these results:

TABLE 12
(headspace analysis)

| Acid/Ca ratio | Free 2MBA |
|---|---|
| 1.3 | 121 |

### Example 13

Another example using a paddle dryer experiment with CaO and IBA with the results:

TABLE 13
(headspace analysis)

| Acid/Ca ratio | Free IBA (ppm) |
|---|---|
| 1.0 | 12 |

### Example 14

Examples 14 and 15 were run continuously in the twin screw extruder, neat as earlier described using the 25k 34 model from Coperion. The calcium source is Ca(OH)2 for each of Examples 14 and 15.

Extruder

TABLE 14
Ca(OH)2-IBA-(headspace analysis)

| Ratio | rpm | HS |
|---|---|---|
| 1:1.5 | 350 | 4308 |
| 1:1.7 | 400 | 5454 |

### Example 15

Extruder

TABLE 15
Ca(OH)2-2MBA-(headspace analysis)

| Ratio | rpm | HS |
|---|---|---|
| 1:1.5 | 540 | 72 ppm |

Example 15 uses 2MBA and Ca(OH)2 at the mole ratio set forth in Table 15.

For each of Examples 14 and 15 headspace (HS) measurements were below 15,000 ppm indicating tolerable work environment odor.

### Comparative Example A (Ammonium Salts of Isoacids)

TABLE A

| Isoacid | Mole Ratio | Headspace, ppm |
|---|---|---|
| nBA | 1:1.9 | 153920 |
| nBA | 1:2 | 184341 |
| IVA | 1:1.9 | 168069 |
| IVA | 1:2 | 177443 |

While smell is subjective one can see that the ammonium salts are all over 150,000 ppm. This will give a very strong odor. Generally speaking, one considers anything under 15,000 ppm to be acceptable in odor.

### Comparative Example B

A hand mixed comparative example was prepared in a similar fashion as was done in previously (example 6) but this time it was done in water (50%) and the water evaporated before testing on the head space. The ratio was Ca(OH)2 to isovaleric acid 1:2

| Ratio | HS ppm |
|---|---|
| 1:2 | 36800 |

The comparative examples demonstrate the criticality of using the correct salt and the importance of a neat reaction.

One can see from the written description and the Examples and the data observed that the invention is operable and is effective at odor reduction and can therefore be commercially effective to prepare nutritionally enriched isoacid nutrients.

What is claimed is:

1. A process of preparing isoacid feed supplements without foul odor problems, comprising:
reacting a calcium metal source selected from the group of calcium oxide and calcium hydroxide in a solid phase with a low molecular weight volatile fatty acid selected from the group consisting of butyric acid, isobutyric acid, 2 methyl butyric acid, valeric acid and isovaleric acid, with the mole ratio of calcium metal source to low molecular weight volatile fatty acid source being with the range of about 1:1 to about 1:2, to provide a substantially odor free calcium salt product, useful as an animal feed ration supplement.

2. The process of claim 1 wherein the ratio of calcium metal source to low molecular weight volatile fatty acid source is within the range of about 1:1.5 to about 1:1.9.

3. The process of claim 1 wherein the process is run in a mechanical mix reactor, without any fat encapsulating additive.

4. The process of claim 3 wherein the process is run neat.

5. The process of claim 3 wherein the process is run in a shear mechanical mixer with a paddle dryer system.

6. The product of the process of claim 1.

7. The reaction product of claim 6 in subdivided form.

8. A feed supplement for ruminants, swine, and poultry with no substantial odor problems comprising a subdivided calcium volatile fatty acid feed source, non-encapsulated, and prepared neat from a calcium metal ion source selected from the group of calcium oxide and calcium hydroxide and a volatile fatty acid selected from the group consisting of butyric acid, isobutyric acid, 2 methyl butyric acid, valeric acid and isovaleric acid, with the mole ratio of calcium oxide or calcium hydroxide to volatile fatty acid being with the range of about 1:1 to about 1:2.

9. The feed supplement of claim 8 wherein the mole ratio of calcium ion source to volatile fatty acid source is about 1:1.5 to 1:1.9.

10. The feed supplement of claim 1 wherein the supplement is prepared in a commercially available mixer.

11. The feed supplement of claim 10 wherein the commercially available mixer is a panel dryer.
